(19) United States
(12) Patent Application Publication
(10) Pub. No.: US 2013/0287934 A1
(43) Pub. Date: Oct. 31, 2013

(54) Liquid Metal Digital Manufacturing System

(71) Applicant: Pallant Satnarine Ramsundar, Petersburg, VA (US)

(72) Inventor: Pallant Satnarine Ramsundar, Petersburg, VA (US)

(73) Assignee: Pallant Satnarine Ramsundar, Petersburg, VA (US)

(21) Appl. No.: 13/867,582

(22) Filed: Apr. 22, 2013

Related U.S. Application Data
(60) Provisional application No. 61/640,712, filed on Apr. 30, 2012.

(51) Int. Cl. B05D 1/38

(52) U.S. Cl. CPC B05D 1/38
USPC 427/9; 427/256

(57) ABSTRACT

A process and apparatus for the production of metal parts by layered manufacturing starting from wire raw material comprising of the steps of; descaling of the wire; creating and maintaining a melt pool of the metal in a melt chamber; expelling controlled amounts of melt from the melt chamber in predetermined layer patterns, which solidify to form a desired object; managing the solidification parameters to achieve the deposit cross sections desired and depositing a removable support material to assist in maintaining the geometry of the desired metal deposit. Said apparatus is capable of higher production rate than other metal layered manufacturing systems available commercially and can be used for any metal alloy or non-metal material that can be supplied in wire form and that is within the melt capacity of this invention.

### CROSS-REFERENCE TO RELATED APPLICATIONS

The present application claims the benefit of the filing date of U.S. Provisional Patent Application No. 61/640,712 filed Apr. 30, 2012, the contents of which are hereby expressly incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

This invention is in the field of layered manufacturing. Layered manufacturing is the construction of a three dimensional object by building a series of thin successive layers one on top of the other.

More particularly, this invention is a method and apparatus for the layered production of metal articles by liquefying the metal and then controlling the deposition and solidification of the layers to produce the required part.

### BACKGROUND OF THE INVENTION

The field of additive manufacturing (AM) has shown explosive growth since the introduction of the stereo-lithography apparatus in 1986 based on the U.S. Pat. No. 4,575,330 filed for C. Hull in 1984. Today a number of companies offer systems for the AM of polymers, ceramics, biomaterials and metals. While we have seen a dramatic decline in the cost of polymer AM systems over the years, the AM systems available for metals are still relatively expensive. Some other limitations on available AM systems for metals are low production rates compared to mass production methods, as well as a limited choice of metal alloys produced on these systems.

This invention aims to produce a metal AM system that is low cost, capable of working with a wide range of metal alloys, and capable of production rates that are higher than current metal AM systems.

Commercial metal AM systems can be described in the following categories:
a) Systems that use a laser or electron beam to consolidate profiles in layers of metal powder.
b) Systems that apply a binder to layers of powdered metal, which require subsequent sintering to consolidate the metal shape.
c) Systems that bond together metal foils and sheets and which require intermediate machining to derive the desired shape.

Principal patents covering metal AM systems using laser or electron beam are as follows:
i. German patent DE 2263777 filed in 1971 for P. Ciraud where the use of a focused energy beam to consolidate powdered material was described.
ii. U.S. Pat. No. 4,247,508 filed in 1979 for R. Householder, where a method to produce a planar layer of material was described and alternative methods for delivering the heating energy.
iii. U.S. Pat. No. 4,863,538 filed for C. Deckard in 1986 described a system called selective sintering, with a laser acting on a powder bed, that has been a forerunner for many of the existing commercial systems for the layered production of metals.
iv. U.S. Pat. No. 4,818,562 filed in 1988 for F. Arcella and G. Lessmann which described a system using a laser acting on a fluidized powder bed to produce a deposit on a surface.
v. U.S. Pat. No. 5,786,562 filed in 1994 for Ralf Larson, where the focused energy beam was an electron beam.
vi. US Patent 20110114839 filed in 2010 for S. Stecker and P. Wollenhaupt where an electron beam acts on solid feed material rather than a powder bed.

Systems that apply a binder to metal powder layers are based on the U.S. Pat. No. 5,204,055 filed in 1989 for M. Cima.

One system for the bonding of metal foils and sheets use the process of ultrasonic consolidation is described in the U.S. Pat. No. 6,519,500 filed for D. White in 2002.

One system for the AM of metals by welding techniques is described in the U.S. Pat. No. 5,207,371 filed in 1991 for F. Prinz et al., in which deposited layers are intermediately milled to improve accuracy.

This present invention requires the liquefaction of metal which is deposited by layered manufacturing and solidified. Though no effective system is commercially available with precisely the same configuration, prior research has been done on metal droplet creation. Principal patents on liquid metal creation and manipulation for layered manufacturing are as follows:
i. U.S. Pat. No. 6,446,878 filed in 2000 for S. Chandra and R. Givraj describing an apparatus for droplet generation using pulsed gas pressure.
ii. U.S. Pat. No. 5,340,090 filed in 1993 for E. Muntz and M. Orme which describes an apparatus for the creation of droplets by applying a disturbance to a liquid stream.
iii. U.S. Pat. No. 5,746,844 filed in 1995 for R. Sterett and A. Sudhalkar which describes a mechanism for charging droplets so that they can be more precisely focused than the system described in US Patent.
iv. U.S. Pat. No. 5,229,016 filed in 1991 for D. Hatnes et al. for the dispensing of molten balls of solder.
v. U.S. Pat. No. 4,828,886 filed in 1987 for H. Heiber, which describes the formation of solder droplets using a piezo-electric transducer.
vi. U.S. Pat. No. 5,266,098 filed in 1992 for J. Chun et al., which describes a metal droplet forming system with multiple exit orifices in which the melt is subject to a transferred vibration and the droplets are charged to control their size.
vii. U.S. Pat. No. 5,609,919 filed in 1996 for D. Yuan et al., which describes a droplet forming system using transferred vibration to a liquid allowed to exit through one or more orifices.
viii. U.S. Pat. No. 6,554,166 filed in 2001 for K. Sato et al, which describes a droplet forming system where the vibrator mechanism is separate from the melt and the vibration is transferred to the melt orifice area by a rod.
ix. U.S. Pat. No. 5,598,200 filed in 1995 for D. Gore, which describes a droplet forming system with the vibrator mechanism separate from the melt and the vibration transferred to the melt orifice area by a rod.
x. U.S. Pat. No. 5,722,479 filed in 1995 for R. Oeftering, which describes a system that generates drops by acoustic energy, with the drops being charged so they can be subsequently deflected to form a desired pattern.
xi. U.S. Pat. No. 5,445,666 filed in 1993 for W. Peschka et al., which describes a system for breaking up a metal stream into droplets by application of an external acoustic force.
xii. U.S. Pat. No. 5,810,988 filed in 1996 for C. Smith et al., which describes a system for droplet generation utilizing any of a multiplicity of vibration generation systems, and also control of the flight of the droplets by electrostatic or electromagnetic means.
xiii. U.S. Pat. No. 5,281,789 filed in 1992 by R. Merz et al., described a system in which droplets are created by the introducing metal into an electric arc.

### BRIEF SUMMARY OF THE INVENTION

The present invention provides a process and device for the layered manufacturing of metal alloys starting from raw materials supplied in the form of wire. The present invention processes any metal alloy with a melting point within its design capability and its principle is applicable to any material that can be supplied in the form of wire, since the operating principle is to liquefy the material to deposit a pattern, which solidifies to form layers of an object.

In one aspect of the invention there is provided a method for holding of metal wire in a coil form and also for feeding it through the system.

In another aspect of the invention there is provided a method for holding of support material and also for feeding it through the system.

In another aspect of the invention there is provided a system to descale the metal wire and keep it in an inert atmosphere thereafter to reduce oxide contamination in the final deposit.

In another aspect of the invention there is provided a melt chamber to create and maintain a melt pool at a desired temperature.

In another aspect of the invention there is provided means to expel melt from the melt chamber in the desired quantities, frequency and geometry.

In another aspect of the invention there is provided means to deposit the melt in specific patterns on a solidification table.

In another aspect of the invention there is provided means to vary the thermal conditions of the melt and solidification table to achieve a desired solidification profile of the deposit.

In another aspect of the invention there is provided means to maintain an inert atmosphere during deposition to reduce oxide and other contamination.

In another aspect of the invention there is provided means to detect conditions and geometry of the deposit, which information would be used to modify subsequent deposits to enhance accuracy of the shape produced.

### BRIEF DESCRIPTION OF DRAWINGS

FIG. 1 shows a front view layout of the present invention.

FIG. 2 is a schematic layout showing the different system components of the present invention for the layered deposition of metals.

FIG. 3 is a schematic layout showing the different system components of the present invention for the layered deposition of support material required to contain and support the layered metal deposit.

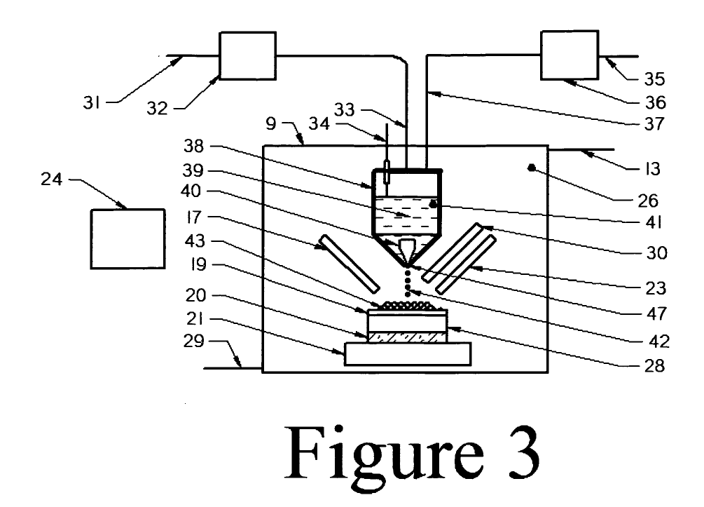

### DETAILED DESCRIPTION OF THE INVENTION

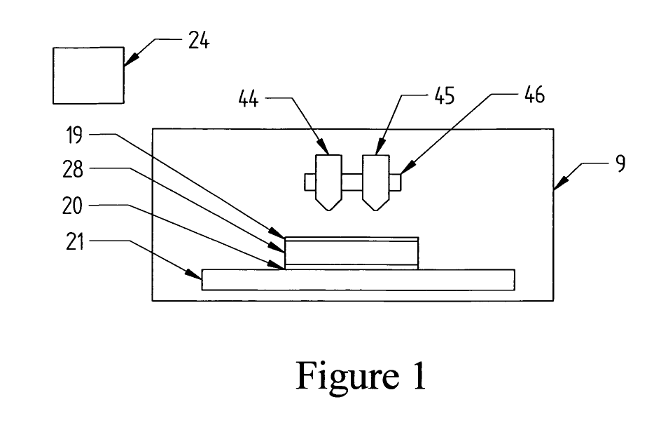

Referring to FIG. 1, the Metal Deposition Head 44 and the Support Material Deposition Head 45 are mounted on a computer numerical control beam 46. The deposits are made on the substrate 19 which rests on the heated block 28. The heated block 28 is insulated from the computer numerical control table 21 by the insulated pad 20. The working area of the apparatus is kept in an inert atmosphere contained in the enclosure 9.

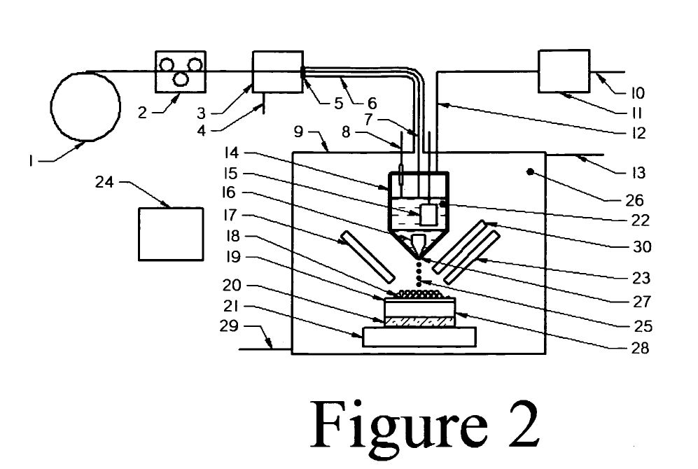

FIG. 2 shows details of the metal deposition head 44. The raw material, supplied as a coil of wire 1 is fed by the wire feeder 2 into a descalar 3 which removes the oxide coating on the wire. The oxide coating removed is disposed through the exhaust port 4 and the clean wire 7 passes through the seal 5 into a passage 6 filled with an inert gas 26. The clean wire 7 terminates into the melt chamber 14. The melt chamber 14 is an air-tight chamber containing the following:
a) Heating elements 15 which acts to liquefy the wire and create a melt pool 22.
b) A liquid level detector 8 which acts in concert with the wire feeder 2 to maintain the liquid level in the melt chamber 14.
c) A nozzle valve 16 which controls the liquid flow through the nozzle exit 27.
d) An entry port for the clean wire 7.
e) An entry port for inert gas 12. The pressure of the inert gas 12 is varied by the pressure control system 11 acting on a supply of inert gas 10. The pressure of this inert gas stream 12, in conjunction with the nozzle valve 16 acting on the nozzle exit 27 controls the flow of liquid metal leaving the melt chamber 14.
   Liquid metal 25 exiting the melt chamber 14 is deposited on a substrate 19 with has its temperature controlled by the heated plate 28. The heated plate 28 rests on the insulated pad 20 with is supported by the computer numerical controlled table 21. The movement of the CNC table 21 determines the pattern of the deposit 18 which solidifies on the substrate 19. A temperature detector 30 measures the temperature of the deposit and is used to control a surface temperature modifier 17, which acts to either direct cooling gas to accelerate solidification of the deposit 18, or to direct an energy beam to heat the deposit surface. 23 is a profile detector which measures the deposit profile dimension. The dimension of the measured deposit profile is used to modify the flow parameters of the subsequent layer deposits to achieve the desired product dimensions.
   To prevent interlayer oxidation of the deposit 18, the deposit head 14 and the various components supporting the deposit 18 are enclosed in an inert atmosphere chamber 9 which maintains the inert atmosphere 26 through the ports 13 and 29.
   The working of the system is managed by the Computer Numerical Control 24, which integrates the operation of the various components to produce the required product.

FIG. 2 shows details of the support material deposition head 45. Slurry 31 is delivered to the pressure chamber 38 by the pump 32 and line 33. A level detector 34 works with the pump 32 to maintain the level of slurry in the pressure chamber 38. The pressure of the inert gas 35 is modified by the controller 36 and delivers pressurized inert gas 37 to the pressure chamber 38. A combination of the pressure provided by the inert gas 37 and the valve 40 acting on the nozzle exit 47 produces a control flow of slurry to be deposited on the substrate 19. Heat provided by the heated block 28 causes the slurry to solidify. The movement of the computer numerical controlled table 21 produces the slurry deposit pattern required for the support material.

The profile detector 23 measures the slurry deposit profile and this information is used to determine the deposit parameters for subsequent slurry layer deposits.
The components are contained in the enclosure 9 which holds an inert atmosphere 26 to keep the deposits free from oxidation.
The advantages of the present invention, without limitation, are:
a) It is usable with commercially available wire feedstock, which permits a wide variety of metal alloys to be produced at the most economical material cost.
b) Because the process is scalable, it is capable of high production rates when compared to existing commercially available AM systems for the direct digital manufacturing of metals.
c) The present invention has lower capital because it uses thermal heating rather than a laser or electron beam, and also because it utilizes wire for the feed stock rather than powdered material, which requires more complex feeding systems.
   While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### PUBLICATIONS

Ramsundar, Pallant. 2011. Wire Feed Metal Deposition. Cambridge: University of Cambridge, 2011. PhD Thesis.

PATENTS

| | Patent No | File Date | Issue Date |
|---|---|---|---|
| German patent | DE2263777 | Dec. 28, 1971 | Jul. 5, 1973 |
| US patent | 4,575,330 | Aug. 8, 1984 | Feb. 12, 1986 |
| US patent | 4,247,508 | Dec. 3, 1979 | Jan. 27, 1981 |
| US patent | 4,863,538 | Oct. 17, 1986 | Sep. 5, 1989 |
| US patent | 4,818,562 | Mar. 24, 1988 | Apr. 4, 1989 |
| US patent | 5,786,562 | May 11, 1994 | Jul. 28, 1998 |
| US patent | 20110114839 | Oct. 12, 2010 | May 19, 2011 |
| US patent | 5,204,055 | Dec. 8, 1989 | Apr. 20, 1993 |
| US patent | 6,519,500 | Mar. 23, 2000 | Feb. 11, 2003 |
| US patent | 5,207,371 | Jul. 29, 1991 | May 4, 1993 |
| US patent | 6,446,878 | Mar. 1, 2000 | Sep. 10, 2002 |
| US patent | 5,340,090 | Mar. 19, 1993 | Aug. 23, 1994 |
| US patent | 5,746,844 | Sep. 8, 1995 | May 5, 1998 |
| US patent | 5,229,016 | Aug. 8, 1991 | Jul. 20, 1993 |
| US patent | 4,828,886 | Nov. 4, 1987 | May 9, 1989 |
| US patent | 5,266,098 | Jan. 7, 1992 | Nov. 30, 1993 |
| US patent | 5,609,919 | Jan. 18, 1996 | Mar. 11, 1997 |
| US patent | 6,554,166 | Mar. 14, 2001 | Apr. 29, 2003 |
| US patent | 5,598,200 | Jan. 26, 1995 | Jan. 28, 1997 |
| US patent | 5,722,479 | Jun. 5, 1995 | Mar. 3, 1998 |
| US patent | 5,445,666 | Dec. 14, 1993 | Aug. 29, 1995 |
| US patent | 5,810,988 | Oct. 1, 1996 | Sep. 22, 1998 |
| US patent | 5,281,789 | Jul. 24, 1992 | Jan. 25, 1994 |

1. A process for the creation of three dimensional objects from wire feed stock comprising the steps of:
a) Creating and maintaining a melt pool in a melt chamber by feeding in raw materials in the form of wire and supplying sufficient heat to melt the material and maintain it at a desired temperature.
b) Controlling the rate of expulsion of the melt through nozzles in the melt chamber.
c) Controlling the deposition pattern of the melt to create layer profiles.
d) Controlling the solidification rate of the melt by controlling the temperature of the melt and the surface on which it is deposited, to obtain the desired three dimensional object.

2. The process of claim 1, wherein the raw material wire is descaled and then maintained in an inert atmosphere to resist re-oxidation.

3. The process of claim 1, wherein the melt in the melt chamber is maintained at a target level by feedback control of the wire feeding mechanism linked to a level sensor in the melt chamber.

4. The process of claim 1, wherein the melt expulsion rate is controlled by a combination of gas pressure in the melt chamber, the size of the nozzle exit and the application of disturbances in the melt flow to refine the flow pattern of the melt flow through nozzle exits.

5. The process of claim 1, wherein the solidification cross section of the deposited melt is achieved by varying the temperatures of the melt and the surface on which it is deposited.

6. The process of claim 1, wherein the solidification cross section of the deposited melt is adjusted based on detection of the variance of the prior deposit from the expectation.

7. The process of claim 1, wherein support material is first deposited as required to form a retaining wall that acts as a mold to allow melt to be deposited in a liquid pool that subsequently solidifies to the shape determined by the retaining wall made from support material.
